(19) United States
(12) Patent Application Publication
(10) Pub. No.: US 2005/0105566 A1
(43) Pub. Date: May 19, 2005

(54) Laser diode arrangement with external resonator

(76) Inventor: Joachim Sacher, Marburg (DE)

Correspondence Address: KLAUS J. BACH, 4407 TWIN OAKS DRIVE, MURRYSVILLE, PA, 15668, US

(21) Appl. No.: 10/783,879

(22) Filed: Feb. 20, 2004

(30) Foreign Application Priority Data
Nov. 19, 2003 (DE) 203 17 901.1

(51) Int. Cl. H01S 3/10

(52) U.S. Cl. 372/20; 372/92; 372/97

(57) ABSTRACT

In a laser diode arrangement for generating single mode tunable laser radiation wherein the laser diode forms a first resonator and has rear and front facets and a second external resonator is coupled to the first resonator, and wherein an optical transmission component and a wavelength selective optical reflection element are arranged in the laser light path from the laser diode for directing laser light into the external resonator and coupling it back into the first resonator, means are provided for uncoupling the laser radiation from the first resonator by way of the rear facet of the laser diode, the rear facet and the optical reflection element having a reflectivity ratio of less than 1.

### BACKGROUND OF THE INVENTION

The invention relates to a laser diode arrangement with an external resonator for the generation of single mode tunable laser radiation with a laser diode which forms a first resonator and an external second resonator coupled thereto for coupling laser light emitted from the laser diode back into the first resonator.

By means of a semiconductor laser diode, which is operated in the flow direction, coherent light can be generated by stimulated emission. Without any stabilization means however such laser light has a relatively large line width. Furthermore, the laser frequency or, respectively, wavelength can be controlled reliably only by way of the laser diode temperature or the injection current.

In order to eliminate these disadvantages, the laser diode is usually combined with an external resonator which, by means of wavelength selective elements such as gratings and filters couples only light of a certain wavelength—the resonator modes—back into the laser diode. This results in an amplification of the stimulated emission of the light of the selected wavelength. At the same time, by way of the wave length selective element, the emission wavelength can be tuned over the amplification range of the laser diode.

Two typical laser arrangements with external resonators which include wavelength selective elements are the Littrow—and the Littman arrangements.

In the Littrow arrangement back-coupling is achieved by way of an optical diffraction grating which is so oriented that light of the first diffraction order is reflected back into the laser diode. The direct reflection (0^{th} refraction order) forms the out-coupling beam of the laser. If the grating is rotated, the system is detuned and another longitudinal resonator mode is amplified.

In the Littman-Metcalf arrangement, the light reaches the optical diffraction grating under a flat angle whereby the diffraction of the first order is directed onto a resonator end mirror. The mirror reflects the light by way of the grating back into the laser diode whereas the diffraction of the 0^{th} order is uncoupled by way of the grating as output. The laser frequency is tuned by a rotation of the mirror. If rotation and translation are coupled at the correct ratio, the laser can be detuned over several THz in a continuous, mode-hop-free manner.

The use of an external resonator generally results in a loss of laser power; at the same time, however, the resonator length becomes to a large extent independent of the temperature. In order to achieve the best possible coupling of the external resonator to the semiconductor laser diode the laser facet facing the laser diode has a low reflectivity of for example less than 0.1%. The rear facet of the laser diode remote from the external resonator has a high reflectivity of as close as possible to 1. The optical diffraction grating of the external resonator has usually a reflectivity of about 5% in order to achieve sufficient back-coupling as well as an acceptable output power.

For increasing the power output, it would be necessary to increase the excitation energy (the injection current) of the laser diode. This however is possible only in a limited way. If too much current flows through the semiconductor laser crystal for too long the laser diode will be destroyed. Although the generation of short laser pulses would avoid this, the output power generated by the pulsed operation or by quality modulation would be available only for a short period which is not sufficient in many applications. An alternative possibility for increasing the output power in a continuously operated laser diode arrangement with external resonator would be to lower the reflectivity of the diffraction grating. But this is also only conditionally possible. If the reflectivity is too low the system properties are detrimentally affected. The laser becomes instable.

It is the object of the present invention to overcome these and other disadvantages of the state of the art and to provide a laser arrangement with an external resonator, which yields a distinctly higher power output. Furthermore, single-mode laser light is to be generated whose wavelength is tunable in a continuous manner and without mode hop. The arrangement should be simple and inexpensive to manufacture and also easy to operate. The imaging properties of the external resonator should be adjustment invariable.

### SUMMARY OF THE INVENTION

In a laser diode arrangement for generating single mode tunable laser radiation, wherein the laser diode forms a first resonator and has rear and front facets and a second, external resonator is coupled to the first resonator, and wherein an optical transmission component and a wavelength selective optical reflection element are arranged in the laser light path from the laser diode for directing laser light into the external resonator and coupling it back into the first resonator, means are provided for uncoupling the laser radiation from the first resonator by way of the rear facet of the laser diode, the rear facet and the optical reflection element having a reflectivity ratio of less than 1.

In this way, a much greater amount of power can be coupled out from the laser diode arrangement, and at the same time, variations in the power output and mode hops in the spectral tuning curve of the laser system can be effectively avoided, particularly if the ratio of the reflectivity of the rear facet and the reflectivity of the optical reflection elements is smaller than 0.1. Preferably, the reflectivity of the rear facet is 1% or less and the reflectivity of the optical reflection element is 95% or greater. These values can be realized in a simple and inexpensive manner.

In axial direction, the laser diode has a length of 500 μm or more which also provides for a noticeable increase in the power that can be uncoupled. At the same time, the line width of the emitted laser radiation is reduced.

Preferably, an optical transmission component such as a collimator lens is arranged adjacent the rear facet. It collimates the laser light emitted divergently from the rear facet. However—depending on the utilization of the light—another optical device may be used in connection with the collimator.

In a preferred embodiment, the arrangement includes a device for changing the quality of coupling the first resonator to the external resonator. In this way, the optical length of the first resonator, which is formed by the laser diode, can be changed in such a way that the two resonators or coupled with each other optimally over the whole wavelength range. As soon as emission radiation power changes occur during tuning of the laser, they can be immediately compensated by an adjustment of the coupling quality. It is therefore possible to generate in a simple manner single-mode mode-hop-free tunable laser radiation. Complicated or expensive mechanical adjustment means at, or in, the external resonator are not needed which greatly simplifies the design and also the operation.

The means for changing the coupling quality are disposed on, or in, the first resonator, which provides for a compact design. To this end, the device for changing the coupling quality comprises an electrical connector contact which is disposed on the laser diode and is divided into connector segments which are controllable independently of one another.

It is advantageous if the connector contact is divided in a plane extending normal to the longitudinal axis of the laser diode and the first connector segment which is adjacent the front facet has an axial length greater than the length of the additional, second connector segment. By means of the second connector segment, the quality of the first resonator can be rapidly and precisely changed without detrimentally affecting the main function of the laser diode.

To each connector segment, a control current can be supplied by way of a control circuit. The control current supplied to the first connector segment remains constant. The control current supplied to the second connector element can be changed by the control circuit depending on the position of the wavelength selective optical reflection elements relative to the laser diode. As a result, the laser light coupled back from the external resonator is more or less amplified by the laser diode in the area of the second connector segment before it enters the main area of the laser diode, which is defined by the first connector segment. With the change in current, the temperature in the active zone of the laser diode and, together therewith, it optical length is changed. Consequently, simply by changing the current at the connector segments, the quality of the resonator formed by the laser diode can be changed in a controllable manner in such a way that the two-resonator system is always coupled in an optimal way.

The quality of the first resonator can be passively changed in that the control current supplied to the second connector segment and the position of the wavelength selective optical reflection element are in a relation to each other which can be determined by the control circuit. When the reflection element, for example a grating, assumes a certain angular position a correspondingly respective current is applied by the control circuit to the second connector segment. If the angular position of the grating is changed for example during tuning of the laser, the control current is adjusted in accordance therewith by the control circuit such that a mode-hop-free laser radiation of constant power is uncoupled.

Additionally, or alternatively, the control current supplied to the second connector segment can be changed depending on the, power of the laser radiation uncoupled from the laser diode arrangement. As soon as, during tuning of the laser, the output power changes with respect to a defined threshold values, the control circuit changes the control current to the second connector section.

For an optimal uncoupling of the laser radiation by way of the wavelength selective element, it is advantageous if the rear facet of the laser diode is high-reflection coated and the front facet of the laser diode facing the external resonator is provided with an antireflection coating. Preferably, the reflectivity of the rear facet is less than 0.1%.

It is advantageous if the laser diode has an active zone, which has a rectangular or trapezoidal shape. The latter prevents the initiation of spatial modes. The beam quality is improved thereby. The trapezoidal shape of the active zone also contributes to an increase of the power output.

Preferably, the optical transmission component is a collimator which directs the divergent light leaving the laser diode as parallel beam bundle onto the wavelength selective reflection element which may be an optical diffraction grating and/or a mirror. Accordingly, the laser diode and the external resonator form a Littman or a Littrow arrangement.

In a particular embodiment, the laser diode is a quantum cascade laser which makes it possible to utilize longer or different wavelength ranges.

In an important embodiment of the invention, wherein the laser diode arrangement includes an optical transmission component, the optical transmission component comprises a collimation lens and a dispersing cylinder lens whose cylinder axis extends essentially parallel to the optical reflection elements.

If the transmission component is so adjusted that the laser facet is depicted point-accurately on the optical reflection element, a line focus is generated by the dispersing cylinder lens. As a result, the laser arrangement becomes adjustment insensitive with respect to tilting of the reflection element or elements about an axis parallel to the longitudinal axis A of the laser diode.

Resonators which are adjustment insensitive are already known. EP-A 203 47 213, for example, proposes a laser diode system with an external resonator in Littrow configuration, which, in addition to a collimation lens and an diffraction grating, includes an anamorphatic transfer range which forms the laser beam in such a way that it generates a line focus on the diffraction grating. To this end, a cylindrical collimation lens is arranged behind the collimator lens, wherein the optical axis of the cylindrical collimation lens extends normal to the grating lines of the resonator grating. Additional prisms are used for expanding the beam in order to increase the width of the laser beam.

This arrangement however requires a multitude of optical components and therefore is also relatively large. A miniaturization of such an arrangement would appear to be very difficult because of the quality problems in the manufacture of short-focus cylinder lenses.

The optical system according to the invention overcomes such disadvantages. It can furthermore be very compact and robust so that the whole laser arrangement can easily withstand mechanical shocks and vibrations. They may even be used in rough industrial environments or in space. The light coupled back from the wavelength selective element is always focused exactly onto the light emitting laser facet so that neither mode hops nor power losses will occur. Expensive compensation mechanisms are not needed.

In specific embodiments the cylinder lens may be arranged between the laser diode and the collimation lens or the collimation lens may be arranged between the laser diode and the cylinder lens.

In another embodiment of the invention, the optical reflection element is formed by two partial gratings which are arranged at an angle of 90° with respect to each other. Also, in this way, the laser arrangement becomes adjustment invariable with respect to the tilting of the partial gratings forming a hat grating normal to the grating lines.

Further features and advantages of the invention will become apparent from the following description of embodiments thereof on the basis of the accompanying drawings.

### BRIEF DESCRIPTION OF THE DRAWINGS

FIG. 1 shows schematically a laser diode in a Littman arrangement,

FIG. 2 shows schematically a laser diode in a Littrow arrangement, and

FIG. 3 is a perspective view of a hat grating for a laser diode in a Littrow arrangement.

### DESCRIPTION OF SPECIFIC EMBODIMENTS

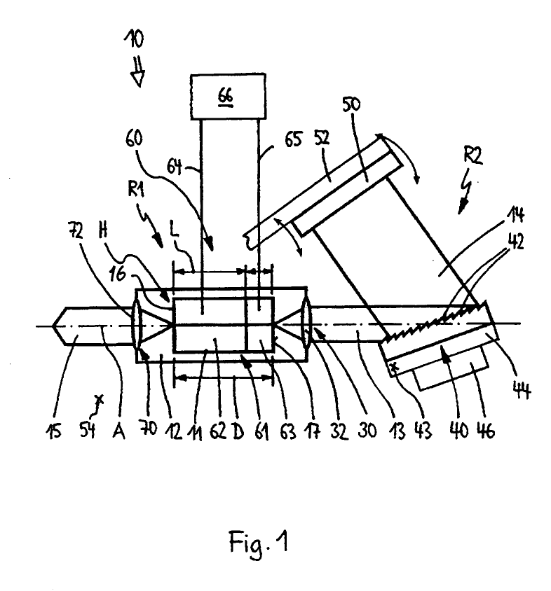

FIG. 1 shows a laser diode arrangement 10 for generating single mode tunable laser radiation 15 in the form of a Littman arrangement. It comprises a semi-conductor laser diode 11, which is mounted on a carrier 12 such as a base plate or a mounting block. The rear facet 16 of the laser diode 11, which has a reflectivity of less than 0.1% and the front facet 17 form the end faces of a first resonator R1 whose length is determined by the length D of the semiconductor crystal of the laser diode 11.

The laser light 13 emitted from the laser facet 17 is focused by an optical transmission component 30 in the form of a rotationally symmetrical collimation lens 32 onto the surface of an optical diffraction grating 40, which, as a wavelength-selective reflection element, is, together with a mirror 50, part of an external resonator R2. The reflectivity of the planar grating 40 is preferably 95% so that a large part of the laser light 14 of the first diffraction order is directed by the grating onto the mirror 50. From there, the light is reflected and—after being diffracted by the grating 40 for a second time—is coupled back into the laser diode 11.

The laser beam 15 is coupled out by way of the rear facet 16 of the laser diode 11, which therefore has a reflectivity of 1% or less that is the ratio of the reflectivity of the rear facet 16 to the reflectivity of the optical grating 40 is much smaller than 1, preferably much smaller than 0.1. In this way, noticeably more power can be obtained from the laser diode arrangement 10 because much more light is coupled from the external resonator R2 back into the laser diode 11. A further increase in the power output can be achieved if the laser diode 11 has, in the axial direction A, a length D which is at least 500 μm.

For a controlled utilization of the laser radiation 15 emitted from the laser diode arrangement 10, an optical transmission component 70 is arranged in the area of the rear facet 16, that is, for example, a collimator lens 72.

The grating 40 is preferably mounted onto a carrier 44 which can be pivoted by adjustment or setting means 46, for example a slide table, about at least one axis 43 parallel to the grating lens 42 or it can be linearly displaced in different spatial directions. The grating lines 42 of the grating 40 extend normal to the longitudinal axis 42 of the laser diode 11.

The mirror 50 is mounted onto a support arm 52, which is pivotably supported about an axis 54. The latter extends parallel to the mirror plane. If the support arm 42 is pivoted about the axis 54, the wavelength coupled by the grating 40 back into the laser diode 11 changes. The laser is detuned. At the same time, the wavelength determined by the length of the external resonator R2 changes which however can be compensated for by a corresponding displacement of the grating 40 relative to the mirror 50, or respective to the pivot axis 54 thereof taking into account several dispersion orders.

Upon tuning of the wavelength by way of the mirror 50, the not-disappearing reflectivity of the front facet 17 of the laser diode facing the external resonator R2 is apparent, in spite of the corresponding adjustment movement of the grating 40, in the form of power output variations and in the form of changes in the resonator quality which usually results in mode hops.

To avoid these effects, the resonator R1 formed by the laser diode 11 is provided with a device 60 by way of which the coupling quality of the first resonator R1 to the external second resonator R2 can be changed in a controllable way. The device 60 comprises essentially an electrical connector contact 61, which is disposed on the laser diode 11 and which is divided in the direction normal to the longitudinal axis A into two separate connector segments 62, 63, and also a control circuit 66. Each connector segment 62, 63 is connected by the way of a connecting line 64, 65 to the control circuit 66, which, in this way, can supply to the connector segments 62, 63 independently control or, respectively, segment currents. It is apparent from FIG. 1 that the first connector segment 62 adjacent the rear facet 16 has a length L, which is greater than the length l of the second connector element 63 and that the total length L+l of the connector segments 62, 63 including a small gap between the segments 62, 63 corresponds to the length D of the laser diode 11. The laser diode 11 is consequently divided by the connector segments 62, 63 into a larger main segment H and an adjacent smaller control segment S.

If, for example, the segment current at the first connector segment 62 is held constant, it is possible, by changing the segment current supplied to the second connector segment 63, to more or less amplify the laser light coupled back from the external resonator R2 in the control segment S before it reaches the main segment H of the laser diode 11. The current change at the second connector segment 63 results in a change of the temperature in the control segment S and a change of the temperature in the active zone of the laser diode 11. As a result, the optical length of the laser diode 11 or, respectively, the resonator R1, can always be optimally coupled to the external resonator R2.

With the separately controllable currents at the connector segments 62, 63 additionally the capability of the first resonator R1 for accepting the laser light coupled back from the external resonator R2 can be controlled which results in a noticeable increase in the laser light yield. For example, with a deteriorating uncoupling, the current supply to the second connector segment 63 can be increased. If the coupling improves, the segment current can again be decreased with further tuning of the wavelength.

The segment currents at the connecting elements 62, 63 are controlled by the control circuit 66, which therefore includes an electronic control. With a passive adaptation of the uncoupling quality, the control current supplied to the second connector segment 63 is changed depending on the position of the grating 40 and/or the mirror 50 relative to the laser diode 11 or, respectively the resonator R1. The current flow and the position of the grating 40 or, respectively, the mirror 5 are in a relation to each other which can be set by the control circuit 66. In this way, it is made sure that, with the tuning of the laser 10, the coupling quality is always adjusted correctly.

In order to automate the adaptation of the coupling quality, the power of the uncoupled laser radiation 15 is measured during the tuning of the wavelength, and the current supplied to the second connector segment 63 is adjusted depending on the power measured and dependent on the angular position of the grating 40 and/or the mirror 50. The laser diode arrangement 10 as a result emits always a single mode laser radiation 15, which can be tuned without any mode hops. Complicated mathematical calculations for determining the pivot axis 54 for the mirror or a complicated position control of the grating 40 are no longer necessary. The whole arrangement 10 can be very compact, it can be made inexpensively and is also simple to operate.

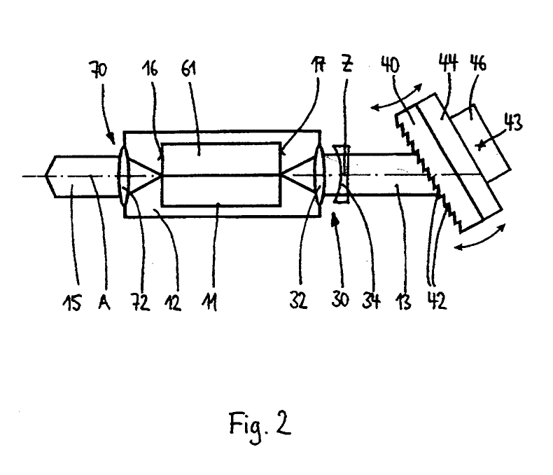

In the embodiment of FIG. 2, the laser diode arrangement 10 forms a Littrow arrangement. A Littrow arrangement comprises essentially the laser diode 11 and the external resonator R2, which is formed by an optical transmission component 30 in the form of a collimation lens 32 and the wavelength selective optical reflection element 40 in the form of a planar diffraction grating as resonator end mirror. Here, the laser light 15 is also coupled out by way of the rear facet 16 of the laser diode 11.

Next to the collimation lens 32, a diffracting cylinder lens 34 is arranged in the beam path of the emitted laser light 13, which has an axis that extends parallel to the grating lines 42 of the grating 40. The position and focus of the cylinder lens 34 are selected in such a way that a line focus is formed on the grating 40 that is the laser light 13 emitted from the laser facet 17 is depicted by the transmission component 30 as a narrow line on the grating 40, the height of the line being much smaller than the width thereof. The latter determines the selectivity of the grating 40.

With this arrangement and such focusing, the laser 10 becomes altogether adjustment invariant with respect to tilting of the grating 40 about an axis normal to the grating lines 42, which may form for example during pivoting of the grating 40 about the axis 43 or by shocks and by vibrations. Furthermore, no output power losses occur as a result of the optical system of the resonator 30, 40, 50, because the imaging properties of the highly compact resonator R2 are always optimal. Consequently, the tuning behavior of the laser arrangement 10 during pivoting of the grating 40 about the axis 43 remains unchanged. The power output yield is very high.

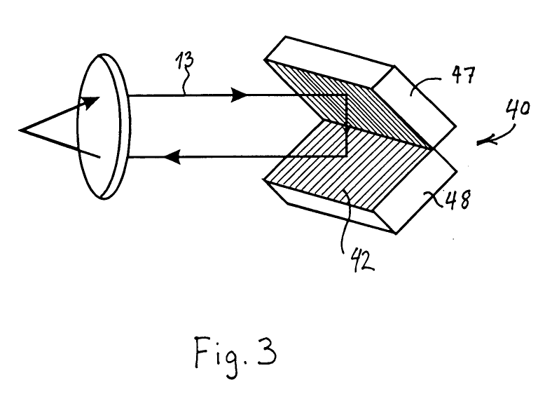

The embodiment of FIG. 3 shows another variant of providing adjustment insensitivity. In this case, the planar refraction grating 40′ of the Littrow arrangement of FIG. 2 is replaced by a hat grating, which is formed by two partial gratings 47, 48, which are arranged at an angle of 90° relative to each other. Incident collimated monochromatic light is parallel-displaced and reflected back in the direction from which it arrived. As a result, the laser becomes adjustment insensitive with respect to tilting of the hat grating 40′ normal to the grating lines 42, while the tuning behavior during pivoting of the grating 40′ about an axis parallel to the grating lines 42 remains unchanged.

The invention is not limited to the embodiments described herein, but may be varied in many ways. In the embodiment of FIG. 1, for example, the preferably rotationally symmetrical collimation lens 32 may, for example, be arranged between the laser diode 11 and the cylinder lens 3 is arranged between the laser diode 11 and the collimation lens 32. In order to further improve the projection of the laser light 13 onto the grating 40, particularly in order to avoid imaging errors, it is expedient to use as the lens 32 an aspheric lens.

The laser diode 11 preferably has an active zone of rectangular shape. In order to prevent an oscillation build up of spatial modes, the active zone may be trapezoidal. Also in this way, the power output can be improved.

In still another embodiment of the laser diode arrangement 10, the laser diode 11 may be a quantum cascade laser. With such arrangement wavelength ranges of 4 μm to 12 μm can be covered which is not possible with conventional lasers. The modification of the laser diode in accordance with the invention provides for an always mode-hop-free tuning possibility.

All the features disclosed and described and shown in the drawings including the spatial arrangements are considered to be part of the present invention.

1. A laser diode arrangement (10) for generating single-mode tunable laser radiation (15), comprising a laser diode (11) having a rear facet (16) and a front facet (17) and forming a first resonator (R1), an external, second resonator (R2) coupled to said first resonator (R1), at least one optical transmission component (30) and at least one wavelength selective optical reflection element (40, 50) arranged in the laser light path between said first and said second resonators R1, R2) for coupling light back into the first resonator (R1) by way of said rear facet (16), the ratio of the reflectivity of the rear facet (16) to the reflectivity of the optical reflection element (40) being smaller than 1.

2. A laser diode arrangement according to claim 1, wherein the ratio of the reflectivity of the rear facet (16) and the reflectivity of the optical reflection element (40) is smaller than 0.1.

3. A laser diode arrangement according to claim 1, wherein the reflectivity of the rear facet (16) is 0.01 or smaller and the reflectivity of the optical reflection element (40) is at least 0.95.

4. A laser diode arrangement according to claim 1, wherein the laser diode (11) has an axial length (10) which is at least 500 μm.

5. A laser diode arrangement according to claim 1, wherein an optical transmission component (70) is arranged adjacent the rear facet (16).

6. A laser diode arrangement according to claim 1, wherein said arrangement includes a structure (60) for changing the quality of coupling of the first resonator (R1) to the second, external resonator (R2).

7. A laser diode arrangement according to claim 6, wherein the structure (60) for changing the coupling quality is disposed on, or in, the first resonator (R1).

8. A laser diode arrangement according to claim 6, wherein the structure (60) for changing the coupling quality of the first and second resonators is disposed on, or in, the laser diode (11).

9. A laser diode arrangement according to claim 6, wherein the structure (60) for changing the coupling quality of the first and second resonators comprises a connector contact (61) which is divided into first and second independently controllable connector segments (62, 63).

10. A laser diode arrangement according to claim 9, wherein said connector contact is divided along a plan extending normal to the longitudinal axis (A) of the laser diode (11) and the first connector segment (62) which is disposed adjacent the rear facet (16) has a length (L) which is greater than the length (l) of the second connector segment (63).

11. A laser diode arrangement according to claim 9, wherein said laser diode arrangement includes a control circuit (66) which is connected to each connector segment (62, 63) for supplying control currents thereto.

12. A laser diode arrangement according to claim 1, wherein the control circuit supplied by said control circuit to said first connector segment (62) is constant.

13. A laser diode arrangement according to claim 12, wherein the control current supplied to said second connector segment 63 is variable depending on the position of the wavelength selective optical reflection elements (40, 50) with respect to the laser diode (11).

14. A laser diode arrangement according to claim 13, wherein the control current supplied to said second connector segment (63) and the position of the wavelength selective optical reflection element or elements (40, 50) are in a relationship which is determinable by said control circuit (68).

15. A laser diode arrangement according to claim 9, wherein the control current supplied to the second connector segment (63) is adjustable depending on the power of the laser radiation coupled out of the laser diode arrangement.

16. A laser diode arrangement according to claim 1, wherein the rear facet of said laser diode is high-reflection coated.

17. A laser diode arrangement according to claim 1, wherein the front facet (17) of the laser diode (11) facing the external resonator (R2) of the laser diode (11) is provided with an antireflection coating.

18. A laser diode arrangement according to claim 17, wherein the reflectivity of the antireflection-coated front facet (17) of said laser diode (11) is less than 0.001.

19. A laser diode arrangement according to claim 1, wherein said laser diode (11) includes a zone which has an active zone of rectangular or trapezoidal shape.

20. A laser diode arrangement according to claim 1, wherein said optical transmission component includes a collimator (32).

21. A laser diode arrangement according to claim 1, wherein said wavelength selective reflection element (40) is an optical diffraction grating.

22. A laser diode arrangement according to claim 1, wherein said wavelength selecting reflection element (50) is a mirror.

23. A laser diode arrangement according to claim 1, wherein said laser diode (11) and said external second resonator (R2) form one of a Littman and a Littrow arrangement.

24. A laser diode arrangement according to claim 1, wherein the laser diode is a quantum cascade laser.

25. A laser diode arrangement (10) for generating a single mode tunable laser radiation (15) comprising a laser diode (11) having a rear facet (16) and a front facet (17) and forming a first resonator (R1), an external, second resonator (R2) coupled to said first resonator (R1), at least one optical transmission component (30) and at least one wavelength selective optical reflective element (40, 50) arranged in the laser light path between the first and second resonators (R1, R2) for coupling laser light from the second resonator (R2) back into the first resonator (R1), said optical transmission component (30) including a diffracting cylinder lens (34) having an axis (2), which extends essentially parallel to the laser diode axis.

26. A laser diode arrangement according to claim 25, wherein said cylinder lens (34) is arranged between the laser diode (11) and the collimator (32).

27. A laser diode arrangement according to claim 25, wherein said collimator (32) is arranged between said laser diode (11) and said cylinder lens (34).

28. A laser diode arrangement according to claim 25, wherein said optical reflection element (40) comprises two partial gratings (47, 48) which are arranged at an angle of 90° relative to each other.
